(19) United States
(12) Patent Application Publication
(10) Pub. No.: US 2026/0154550 A1
(43) Pub. Date: Jun. 4, 2026

(54) Neural Network Methods for Describing System Topologies

(71) Applicant: PassiveLogic, Inc., Holladay, UT (US)

(72) Inventors: Troy Aaron Harvey, Holladay, UT (US); Jeremy David Fillingim, Salt Lake City, UT (US)

(73) Assignee: PassiveLogic, Inc., Holladay, UT (US)

(21) Appl. No.: 19/450,560

(22) Filed: Jan. 15, 2026

Related U.S. Application Data
(63) Continuation of application No. 17/009,713, filed on Sep. 1, 2020, now Pat. No. 12,572,807.
(60) Provisional application No. 62/704,976, filed on Jun. 5, 2020.

(51) Int. Cl. G06N 3/084; B60H 1/00; F24F 11/64; F24F 11/65; F24F 120/10; F24F 120/20; F24F 140/50; G05B 13/02; G05B 13/04; G05B 19/042; G06F 17/16; G06F 30/18; G06F 30/27; G06F 119/06; G06F 119/08; G06N 3/04; G06N 3/047; G06N 3/048; G06N 3/063; G06N 3/08; G06Q 10/067; G06Q 50/163

(52) U.S. Cl. CPC G06N 3/084; B60H 1/00285; F24F 11/64; F24F 11/65; G05B 13/027; G05B 13/04; G05B 19/042; G06F 17/16; G06F 30/18; G06F 30/27; G06N 3/04; G06N 3/047; G06N 3/048; G06N 3/063; G06N 3/08; G06Q 10/067; G06Q 50/163; F24F 2120/10; F24F 2120/20; F24F 2140/50; G05B 2219/2614; G06F 2119/06; G06F 2119/08

(57) ABSTRACT

A neural network in one embodiment is built by decomposing a structure into different building materials creating neurons that represent building materials and open spaces in a structure. Subsystems in the building have their neurons concatenated together to create same length neuron strings. In some embodiments, neurons in a short neuron string are split to make longer neuron strings. In some embodiments, neurons are added to some neuron strings to represent inside features, air features, and outside features.

### RELATED APPLICATION

This application is a continuation of U.S. patent application Ser. No. 17/009,713, filed Sep. 1, 2020, which claims priority to U.S. Provisional Patent Application Ser. No. 62/704,976, filed Jun. 5, 2020. The entire contents of U.S. patent application Ser. No. 17/009,713 and U.S. Provisional Patent Application Ser. No. 62/704,976 are hereby incorporated by reference in their entirety for all purposes.

### FIELD

The present disclosure relates to neural network methods for describing system topologies. More specifically the present disclosure relates to creating thermodynamic models of spaces with same-length neuron strings.

### BACKGROUND

Deep learning artificial neural nets are generally built with neurons with weight and connections. The neurons are arranged into an input layer, one or more hidden layers, and an output layer. The neural net learns by having training sets fed into the input neurons; the information flows through the hidden layers to the outputs, where it is then analyzed. Then, based on how different the output at each location is from the desired results, and how output neurons are affecting the input neurons, the weights and connections within the neural network are modified. Once an artificial neural net has been sufficiently trained, it can work surprisingly well for many types of problems, including speech recognition, object identification, game playing, pattern recognition, and so on.

However, the hidden layers are well and truly hidden. This “outside-the-box-looking-in” approach can provide information, but when results are not as expected it is very difficult to troubleshoot, as how the answers are arrived at are shrouded in darkness. Looking at the weights and measures of a trained neural net shows no discernible relationship between the input and the output. So, correctly designing and training artificial neural networks relies on the administrator having a great deal of knowledge about the system to understand the problem to be able to infer what might possibly be happening. Even then, if there are unexpected results, figuring out why can be close to unsolvable. This problem is amplified when attempting to model buildings, as the various layers of material in a building behave differently and affect each other in difficult-to-anticipate ways, so it is difficult to even tell if the results are unexpected, let alone incorrect.

Trying to model buildings quickly runs into problems, as even simple buildings are very complex in terms of the current controllers that are used to manage the systems in buildings. Proportional-Integral-Derivative controllers (PID controllers)—originally designed for ship steering in 1922—are widely used to control HVAC and other systems in building, but fit very poorly into creating models that have more than a single setpoint. To model a room thermodynamically, you would need roughly 50 PID controllers; why so many? The walls are made of multiple materials that transfer state differently, and there are four walls, typically; the ceiling and floor are made of different levels of materials, forces act on the outside of the walls; there are heat sources, such as people and lights in the room, all of which together make up the building. Trying to model all those PIDs for a single room is very difficult. Using such methods to model an entire building quickly becomes close to computationally impossible, both because of the complexity of all the interactions, and because of the huge amount of computer time that would be required. Using a traditional neural network to model all the individual portions of a building would take an absurd time to run, and would require an unreasonable number of training sets.

### SUMMARY

This summary is provided to introduce a selection of concepts in a simplified form that are further described below in the Detailed Description section. This summary does not identify required or essential features of the claimed subject matter.

In general, one innovative embodiment comprises a neuron model creation system. This system comprises at least one processor, a memory in operable communication with the processor and neural model discretization code residing in memory. The model discretization code comprises an element determiner which determines structure elements for subsystems in a digital representation of a structure. These subsystems may be masses in a structure, such as walls, ceilings and floors. The structure elements may be materials in the masses, such as insulation, cladding material, and so forth. A neuron builder builds a neuron for each structure element in the first subsystem and the second subsystem. These neurons comprise an input, an output, at least one parameter, and a label. Parameter values are added that relate to values in the structure elements. A discretizer builds extra neurons such that subsystem is represented by an equal-length neuron string.

The foregoing and other embodiments can each optionally include one or more of the following features, alone or in combination. In particular, in an illustrative embodiment, a neuron is split into two neurons. This split divides some parameter values in half in the resulting neurons. A neuron concatenator links the neurons together such that information travels along the string.

In an embodiment, the neuron builder builds an inner neuron which comprises representation of state within the structure, and which is concatenated to a neuron string. In an embodiment, inner neurons and outer neurons can be attached to each end of a neuron string. Ground neurons and inner air neurons which represent state of the ground and state of air can also added to neuron strings.

In an embodiment, a neural network with two rooms is described. A set of neuron strings can be associated with each room. A wall is shared between the two rooms in the structure represented by the neural strings. The wall can be represented by a single wall string in the the set of neuron strings associated with the first room. An inner neuron associated with the second room can be attached to the string representing the shared wall in the first room.

Additional features and advantages will become apparent from the following detailed description of illustrated embodiments, which proceeds with reference to accompanying drawings.

### BRIEF DESCRIPTION OF THE FIGURES

FIG. 1 is a functional block diagram showing an exemplary embodiment of a neuron model discretization and creation system in conjunction which described embodiments can be implemented.

FIG. 2 is a functional block diagram showing an exemplary embodiment of subsystems and neurons in conjunction which described embodiments can be implemented.

FIG. 3 is a diagram showing an exemplary embodiment of a structure in conjunction with which described embodiments can be implemented.

FIG. 4 is a functional block diagram illustrating an embodiment of different structural representations with which described embodiments can be implemented.

FIG. 5 is a functional block diagram illustrating an embodiment of example neurons in conjunction with which described embodiments can be implemented.

FIG. 5A is a functional block diagram that is a refinement of FIG. 5, illustrating an embodiment of split neurons in conjunction with which described embodiments can be implemented.

FIG. 6 is a functional block diagram illustrating an exemplary embodiment of splitting neurons with which described embodiments can be implemented.

FIG. 7 is a functional block diagram illustrating an exemplary embodiment of concatenated neurons in conjunction with which described embodiments can be implemented.

FIG. 8 is a functional block diagram illustrating an exemplary embodiment of the relationship between materials and parameters in conjunction with which described embodiments can be implemented.

FIG. 9 is a functional block diagram illustrating an exemplary embodiment of state parameters in conjunction with which described embodiments can be implemented.

FIG. 10 is a functional block diagram that illustrates an exemplary group of neuron strings with inner and outer neurons in conjunction with which described embodiments can be implemented.

FIG. 11 is an operational flow diagram showing an exemplary neural network creation and discretization method.

FIG. 12 is a functional block diagram that illustrates an exemplary set of zones that share a wall in conjunction with which described embodiments can be implemented.

FIG. 13 is a functional block diagram that illustrates an exemplary group of neuron strings that represent zones with a shared wall in conjunction with which described embodiments can be implemented.

FIG. 14 is a functional block diagram that illustrates an exemplary neuron string with a ground neuron in conjunction with which described embodiments can be implemented.

FIG. 15 is a functional block diagram that illustrates an exemplary neuron string with an indoor air neuron in conjunction with which described embodiments can be implemented.

FIG. 16 is a functional block diagram that illustrates exemplary parameter types which described embodiments can be implemented.

FIG. 17 is a functional block diagram that illustrates exemplary computer storage media with which described embodiments can be implemented.

FIG. 18 is a functional block diagram that illustrates an exemplary neuron string with a outer convection neuron in conjunction with which described embodiments can be implemented.

FIG. 19 is a block diagram of an exemplary computing environment in conjunction with which described embodiments can be implemented.

### DETAILED DESCRIPTION

Disclosed below are representative embodiments of methods, computer-readable media, and systems having particular applicability to systems and methods for building neural networks that describe physical structures. Described embodiments implement one or more of the described technologies.

Various alternatives to the implementations described herein are possible. For example, embodiments described with reference to flowchart diagrams can be altered, such as, for example, by changing the ordering of stages shown in the flowcharts, or by repeating or omitting certain stages.

### I. Overview

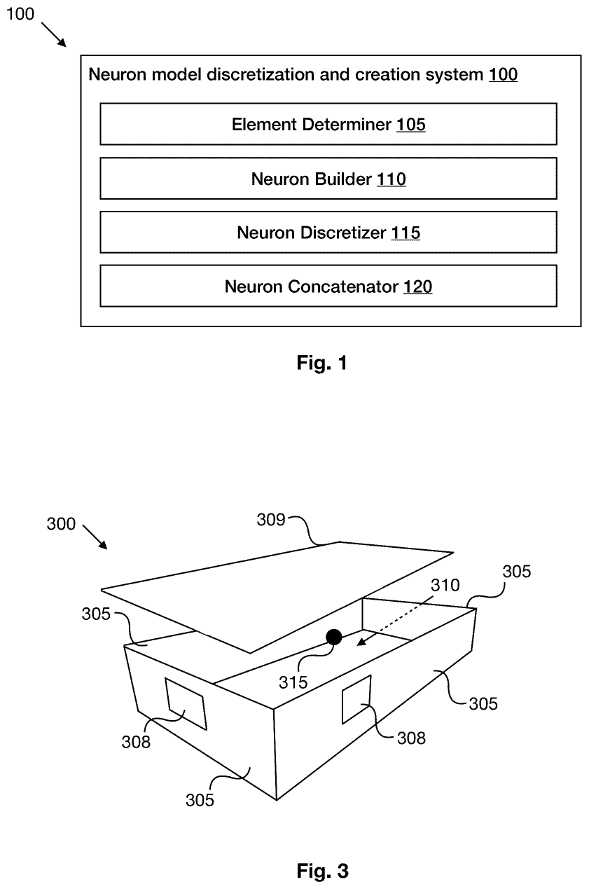

In an exemplary environment, a neuron model system comprises neurons that represent individual material layers of a building and various values, such as their resistance and capacitance. These neurons are formed into parallel and branchless neural network strings that propagate heat (or other state values) through them. With reference to FIG. 1, an embodiment of the neuron model discretization and creation system 100 is shown. Process block 105 shows an element determiner. This element determiner 105 determines structure elements for at least a first subsystem and a second subsystem in a digital representation of a structure. When a digital representation of a building is input into an automation system, the component portions of the building that have different thermodynamic qualities are generally defined. These (for an embodiment), may be broken down, in decreasing complexity, into building, floor, zone, surface, layer, and materials. Layers are composed of materials, surfaces are composed of layers, and so on. Structure elements are these component portions of the building.

Which specific component portions of the building are used depends on the implementation model. Some models may be at a very high level, and so may have structure elements that are composed of floors, for example. Other models may be at a very low level, and so may use structure elements at the materials level. Other models may choose structure elements from different levels, such as some structure elements at a layer level, while other structure elements are at a material level. Other choices are possible as well.

Some structures comprise multiple zones (such as rooms or specific areas monitored by a sensor). Each separate zone may be modeled by its own neural model. The collection of neural models can comprise the thermodynamic model of the structure. In such a multiple zone model, when zones share a surface, such as (in a building implementation), a wall, a floor, or a ceiling, the outside neuron of one neural model may be used as the inner neuron of the next. Some zones may overlap with other zones, while some zones do not. The entire structure may be covered in zones, or some locations within a structure may have no explicit zone. Defined spaces may be defined into multiple subsystems. Any of these portioned defined spaces may be used as the subsystems.

In some embodiments, a structure is a defined space. That defined space may be a building, a portion of a building, a room, a portion of a room, an outside area such as a garden, and so on. This may be a space that currently exists, or may be a space that exists only as a design.

Process block 110 shows a neuron builder. This builder builds a neuron for each structure element in the first subsystem and the second subsystem, each neuron comprising: an input, an output, a parameter, and a label.

Process block 115 shows a neuron discretizer that builds extra neurons for each subsystem that has fewer structure elements that a subsystem with greatest number of structure elements, such that each subsystem has equal number of structure elements. Process block 120 shows a neuron concatenator. The neuron concatenator concatenates the neurons associated with the first subsystem making a first neuron string; and concatenates the neurons associated with the second subsystem making a second neuron string. The neurons are concatenated such that data is operationally able to be transferred along the concatenated neuron string.

### II. Exemplary System for Discretation and Creation of Neuron Models

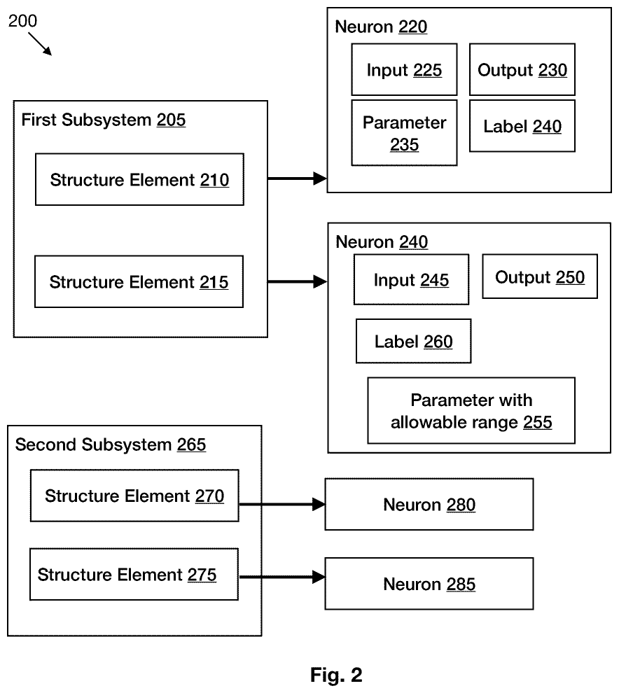

FIG. 2 at 200 shows an exemplary embodiment that can be used to create and discretize a neuron model system. A neuron builder 110 builds a neuron for each structure element in a first subsystem 205 and a second subsystem 265. Each subsystem comprises structure elements 210, 215, 270, 275. The structure elements comprise neurons 220, 240, 280, 285. The neurons 220, 240 comprise an input 225, 245, an output 230, 250, a parameter 235, 255, and a label 240, 260. Some parameters 255 may have an allowable range. In such cases, the values allowed to be held within that parameter are constrained in some way. The constraint is any that may be understood by one of skill in the art, such as only certain values are allowed, values between two values are allowed, only whole numbers are allowed, values greater or lesser than a certain value are allowed, and so forth. Other implementations include other parameters, or lack some of these parameters. In some implementations, neurons have key values that are used to look up multiple values in a database. In some implementations, neuron parameters represent equipment parameters, with some of the parameters having an allowable range of values. These parameters may be parameters of a function, and the function may be a thermodynamic function, such as a physics equation.

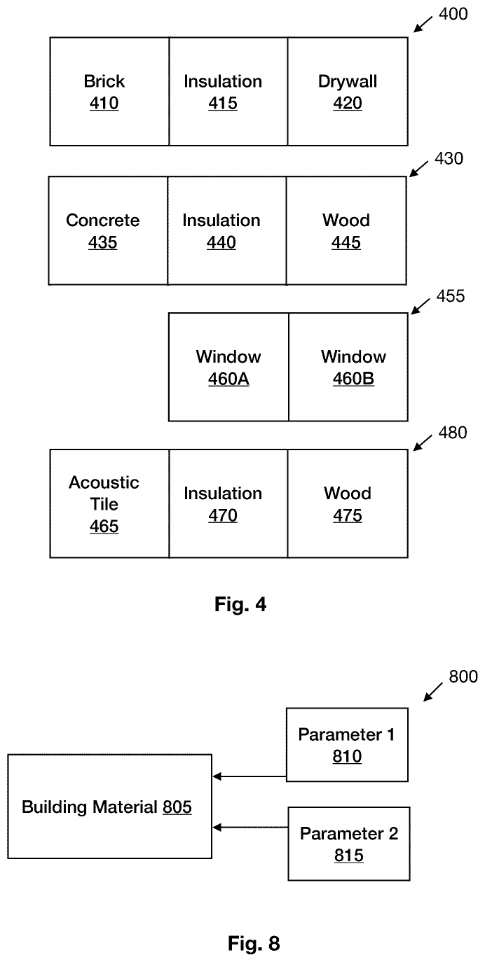

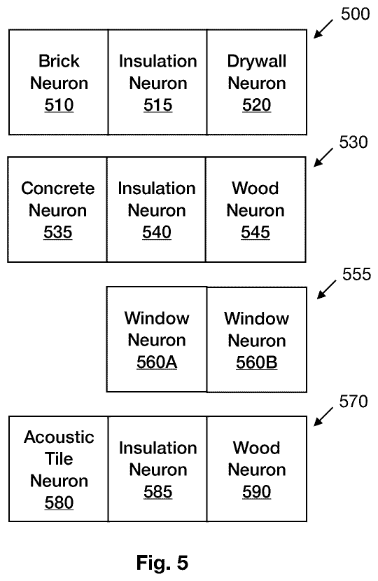

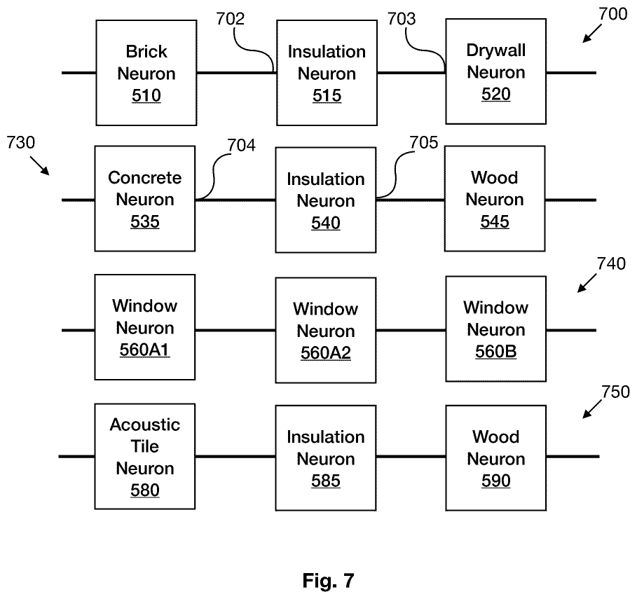

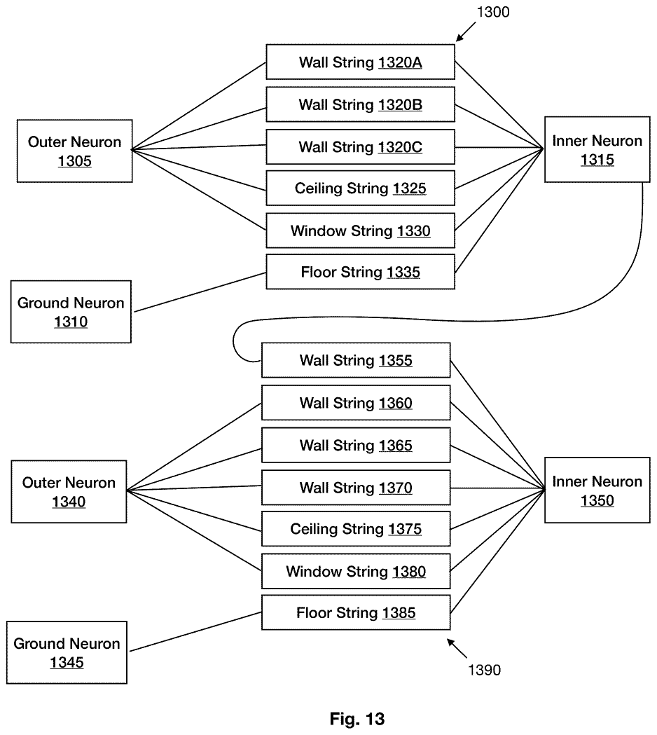

As a brief overview, a structure is deconstructed into major masses, such as windows, floors, ceiling, and the like. Each of these major masses is further deconstructed into physical structural elements such as outside covering (such as wood), insulation, inside wall surface (such as drywall), etc, as shown with reference to FIG. 4. The major masses are then represented within the neural net as subsystems, as shown at FIG. 5, with reference to 530, 555, 570; which are turned into neuron strings, as shown with reference to FIG. 7, which themselves are grouped into neural net sets, as shown in FIG. 13.

With reference to FIG. 3, in an illustrative embodiment, a structure 300 is shown. The component portions of a building (in this case) that have different thermodynamic qualities are generally defined. These (for an embodiment), may be broken down, in decreasing complexity, into building, floor, zone, surface, layer, and materials. Layers are composed of materials, surfaces are composed of layers, and so on. In some embodiments rather than using the entire structure, the structure space is disaggregated, and then the state space is reduced by using relevant parts of system.

In an exemplary example, a model is built to represent a structure 300 comprising a single zone, or room. The model comprises the main thermodynamic masses (or thermal masses) in the space, e.g., four walls 305, windows on outside walls 308, a floor 310, and ceiling 309. An additional mass 315 represents properties within the zone, such as air. These major masses have separate thermodynamic qualities.

With reference to FIG. 4, the different masses of the building 300 are shown. Walls 400 comprise a brick layer 410, an insulation layer 415, and drywall 420. The floor 430 has a concrete layer 435, an insulation layer 440, and a wood layer 445. In this embodiment, rather than being included in the wall layer, both windows 455 are represented as a window layer 455 with two windows 460A and 460B. The ceiling has an acoustic tile layer 465, an insulation layer, and a wood layer 475. Similarly named layers may have different properties, represented by different parameter values. For example, the insulation layers 415, 440, and 470 may all have different properties.

These different layers and their properties of the system shown in FIG. 4 are used to create an artificial neural network. With continuing reference to FIG. 1, an element determiner 105 determines structure elements for at least a first subsystem and a second subsystem in a digital representation of a structure. With reference to FIG. 5, and continuing reference to FIG. 2, neurons are built that represent the physical layers (or other hierarchical elements) of a structure, e.g., 300. Creating these neurons comprises giving parameter (or parameters) associated with various types of material values that represent the thermodynamic properties of such material to the neurons. The neurons may also be given other properties of the physical layer, such as thickness.

A first subsystem 205 may be neurons 500 that represent the outer walls 305. These could comprise a brick neuron 510, insulation neuron 515, and a drywall neuron 520, built with reference to the structure elements 410, 415, and 420. In this embodiment, the wall 305 contain a window 308, but the wall string 500 ignores the window 308. The window has a separate element 455 which gives rise to a separate neuron string 555, discussed later.

Similarly, a second subsystem 265 may be a digital representation of the floor 310, built in reference to structure elements 435, 440, and 445, and shown at 530 with a concrete neuron 535, an insulation neuron 540, and a wood neuron 545.

The windows 308, 455 make up a further subsystem and comprise the window neurons 460A and 460B, which are built to represent the two windows 308. Windows may also be represented by a number of different layers, such as by assigning different panes in the window to different neurons with different values. The windows within a structure or zone may be then grouped together to form an all-window set of neurons 555, with a given neuron representing a given window —that is, having parameter values that reflect that window's thermodynamic behavior. Other material than windows may also be grouped together to form their own set of neurons.

The ceiling subsystem 309, 480 has an acoustic tile neuron 580, an insulation neuron 470, 585, and a wood neuron 590 that are built with regard to structural elements 465, 470, and 475. Each separate neuron may have different parameters representing different properties of the materials in the structure 300. For example, the insulation neurons 415, 440, and 470 may all have different parameter values representing different properties of the different type of insulation (that is to be) used in each location.

With continuing reference to FIG. 1, Process block 115 shows a neuron discretizer that builds extra neurons for each subsystem that has fewer structure elements that a subsystem with greatest number of structure elements, such that each subsystem has equal number of structure elements.

FIG. 5A shows an illustrative embodiment of this process in greater detail. The subsystem with the greatest number of neurons is determined. Then, each subsystem with fewer neurons will have neurons added until each subsystem has an equal number of neurons. Wall neuron subsystem 500, floor neuron subsystem 530, and ceiling neuron subsystem 570 all have three neurons. However window neuron subsystem 555 has only two neurons. Therefore, the window neuron subsystem will replace the original neuron 560A with two neurons, 560A1 and 560A2 creating the neuron subsystem 555A. Window Neuron 560B remains the same.

In some embodiments, to create a new neuron, a neurons are split, with each split neuron being given a fractional values such that the duplicated neurons plus the original neuron all together have the same value as the original neuron. A neuron that is split into two will have values in both new neurons that are one-half the value of the original neuron; a neuron that is split into four will have values that are one-fourth the original value, and so forth.

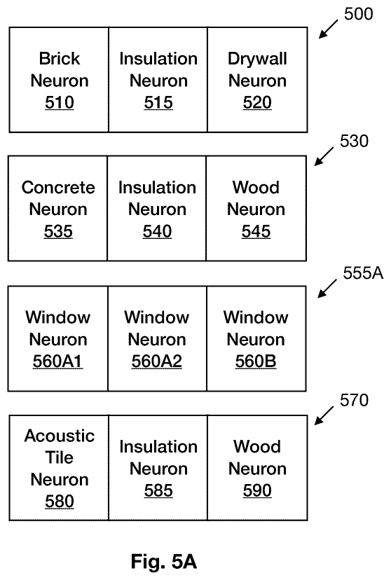

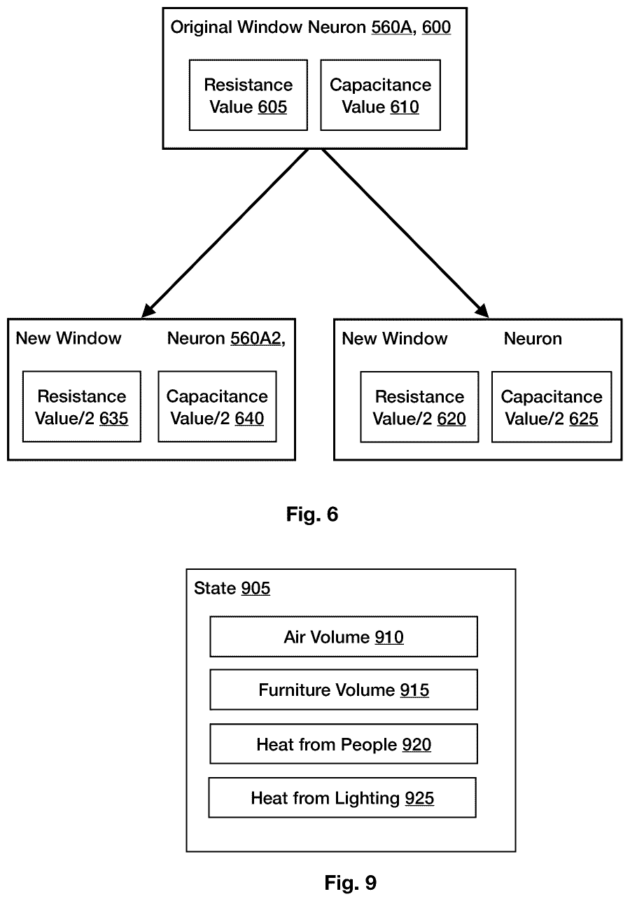

An example embodiment of split neurons is shown in FIG. 6. An original neuron 600, such as the window neuron 560A is shown. It comprises two parameters (such as parameter 235 in FIG. 2), that will be modified during the splitting. These two parameters hold, e.g., a resistance value 605 and a capacitance value 610. This neuron is split into two neurons 560A1, 615, and 560A2, 630. Each of these new neurons resistance value 620, 635 is given ½ of the of the resistance value 605 of the original neuron 600. Adding up the resistance value of 620, and 635 will give the value of the original neuron's resistance value 605. Each of these new neurons capacitance value 625, 640 also is given ½ of the of the original capacitance value 610 of the original neuron 600. These new capacitance values 625, 640 will add up to the original neuron capacitance value 610. Each new neuron may also have parameter values (such as input and output, shown at FIG. 2 at 225 and 230) which may be changed, such that the inputs and outputs are connected so that one neuron's input is the next neuron's output, as discussed with reference to concatenation. Some split neurons may have parameter values that are not changed.

In an embodiment, to determine which neuron to split, two parameter values are multiplied together in the neuron's subsystem to produce a split value for each neuron. The neuron with the highest split value will be the one that is split. With reference to FIG. 8, values in the neurons are determined by values in the materials the neurons are representing, as shown at 800. A building material 805 has various values associated with it, such as Parameter 1 810, and Parameter 2, 815. One or more of these material parameters, or a function of these parameters, are passed on to the neurons associated with these materials. So, a specific insulation material will have parameters associated with it that will then be reflected in values in the neurons that represent that specific insulation layer. With reference to FIG. 6, A representative neuron 600 has two parameters shown, a resistance parameter 605 and a capacitance parameter 610. In this embodiment, the resistance parameter 605 value and the capacitance value 610 will be multiplied together, producing a split value. This will be done for each neuron in a subsystem, such as the wall subsystem 500. The neuron associated with the largest split value is then split as described above.

Once the neurons are split (if necessary), the neurons are concatenated such that neurons associated with the first subsystem make a first neuron string, as can be seen with reference to FIG. 7 at 700. The neurons associated with the second subsystem are also concatenated making a second neuron string 730. This comprises the input of each next one of the neurons in a neuron string being connected to the output of a preceding one of the neurons, such that data is operationally able to be transferred along the concatenated neuron string. As an example, the set of wall neurons 700 are linked together in a series such that the brick neuron 510 is linked 702 to the insulation neuron 515, which is linked 703 to drywall neuron 520. Similarly, the floor neurons 730 are linked such that concrete neuron 535 is linked 704 to insulation neuron 540, which is linked 705 to wood neuron 545. Window neurons 740 and ceiling neurons 750 are also linked together, forming their own neuron strings.

As to how the neurons are linked, with reference to FIG. 2, an illustrative neuron 220 shows an input 225 and an output 230. The output 230 of the brick neuron 510 is set to the insulation neuron 515; the input of the insulation neuron 515 is set to the brick neuron 510; the output of the insulation neuron is set to the drywall neuron 520. These concatenated neurons 700 make a first neuron string. The concatenated neurons 730 make a second neuron string. Those of skill in the art will recognize that there are other equally valid ways to concatenate neurons all of which are covered herein.

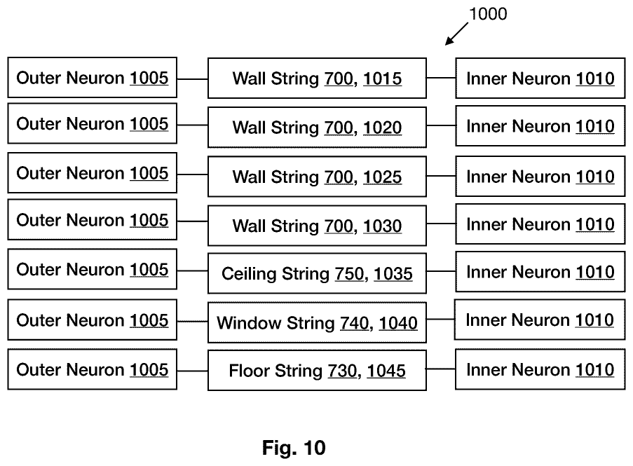

With reference to FIG. 10, and continuing reference to FIG. 3, a neural string set 1015, 1020, 1025, 1030, 1035, 1040, 1045, representing the structure 300 is shown. Notice that the illustrative structure 300 has four identical walls 305 aside from window placement. Each wall 500 will have its own neuron string, for a total of four wall strings in a neural string set representing the structure 300, as shown in FIG. 10 at 1015, 1020, 1025, and 1030. These neural strings shown are simplified for clarity. For example, the wall string 1015 can be seen with more detail in FIG. 7 at 700.

In an illustrative embodiment, the neuron builder builds an inner neuron 1010 which comprises representation of state within the structure, such as shown at 315 in FIG. 3. The inner neuron is concatenated to the first neuron string, using systems and methods as have been explained, e.g., with reference to FIG. 7.

With reference to FIG. 9, the inner neuron may comprise parameter (or state 905) values that are a combination of one or more of air volume in the inside of the structure 910 (or zone within the structure), furniture volume 915, heat associated with people in the structure 920, heat associated with lighting in the structure 925, other state modifiers within the space, temperature, roughness of surfaces, or angle of surfaces. In the illustrative embodiment, identical inner neurons 1010 are concatenated to each neuron string in the neural string set. Other embodiments have different inner neurons connected to different neural strings within the neural string set.

In an exemplary embodiment, the neuron strings making up the neuron string set 1000 are all the same length. This allows them to be run in parallel on a vector processor, greatly speeding up execution time. In another embodiment, some of the neuron strings in a neuron string set are the same length, such that that portion of the neuron string set can be run on a vector processor.

In an illustrative embodiment, with reference to FIG. 10, the neuron builder builds an outer neuron 1005, which comprises representation of state outside the structure. A “state” as used herein and throughout, may be Air Temperature, Radiant Temperature, Atmospheric Pressure, Sound Pressure, Occupancy Amount, Indoor Air Quality, CO2 concentration, Light Intensity, or another state that can be measured and controlled.

The outer neuron is concatenated to the first neuron string, using systems and methods as have been explained, e.g., with reference to FIG. 7. The outer neuron may comprise parameter values that are a combination of one or more of outside temperature, wind speed, wind angle, roughness of outside surfaces, etc. The outer neuron 1005 may be concatenated to all strings within a string set (that represents a room or a zone, etc.) that are at the boundary between the structure and the outside air. Different orientation of the building may result in different parameter values for some outer neurons. Some embodiments may use different outer neurons in some locations.

### III. Exemplary Method for Discretization and Creation of Neuron Models

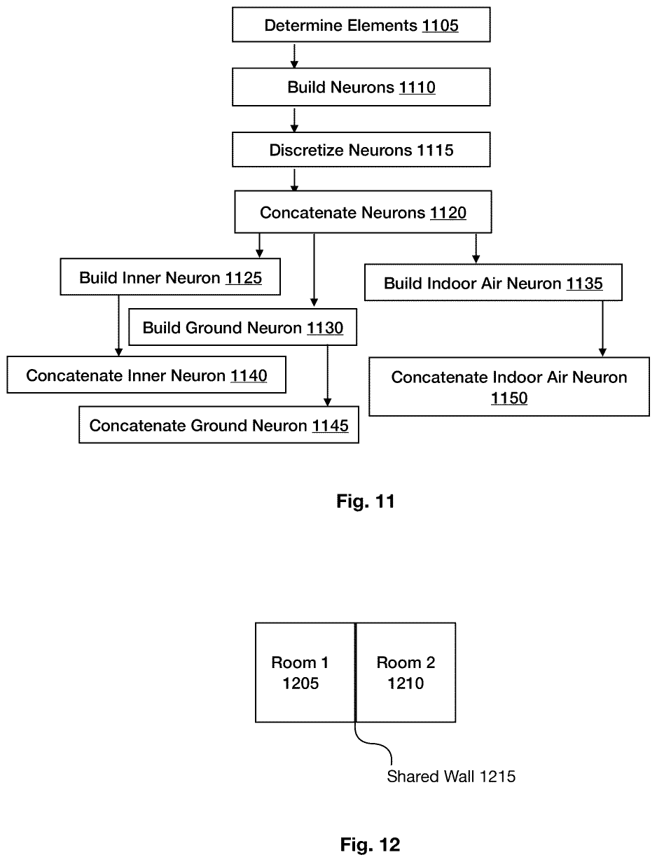

With reference to FIG. 11, an exemplary method for discretion and creation of neuron models is described. At 1105, structure elements are determined for at least a first subsystem and a second subsystem in a digital representation of a structure. This is described in more detail at. e.g., FIGS. 2, 3, and 4, and the text associated therewith. At 1110, a neuron is built for each structure element in the first subsystem and the second subsystem. This is discussed in more detail at. e.g., FIGS. 2 and 5. Each neuron comprises an input, an output, a parameter, and a label. This is discussed at, e.g., FIG. 2, FIGS. 8-9, and throughout. At 1115, a neuron discretizer builds extra neurons for each subsystem that has fewer structure elements that a subsystem with greatest number of structure elements, such that each subsystem has equal number of structure elements. This is described in more detail with reference to FIGS. 5, 5A, and 6 and the text associated therewith.

At 1120, the neurons associated with the first subsystem are concatenated, making a first neuron string. The neurons associated with the second subsystem are also concatenated, making a second neuron string. The input of each next one of the neurons in a neuron string is connected to the output of a preceding neurons such that data is operationally able to be transferred along the concatenated neuron string. This is described in more detail with reference to FIGS. 7, 8, and 9, and with reference to the associated text.

At 1125, an inner neuron is built. This is described in more detail with reference to FIG. 10 and the associated text therein. At process block 1130, an outside neuron is built. Here, an outside neuron is equivalent to an outer neuron. This is described in more detail with reference to FIG. 10 and the associated text therein. At 1140, the inner neuron is concatenated to a neuron string. In an exemplary embodiment, the inner neuron is concatenated to a neuron whose structure element touches inside air, that is, an interior surface neuron. With reference to FIG. 14, the inner neuron 1410 is concatenated to the interior surface wood neuron 545.

At 1130, a ground neuron is built. With reference to FIG. 13, a ground neuron 1310 comprises state changes from the ground that affect surfaces touching the ground. These may include ground temperature, and resistance and capacitance value representing energy transferred from the ground to the surface materials touching the ground. As such, the ground neuron is concatenated to a neuron whose physical analog to a structure element touches the ground. At 1145, the ground neuron 1310 is concatenated to an existing neuron string 1315. In the illustrative example, with reference to FIG. 7. the floor string 730 is concatenated to the ground neuron 1310 prior to the concrete neuron, as seen in FIG. 14 at 1405, with the ground neuron 1405 being concatenated to the concrete neuron 535.

At 1135, an indoor air neuron is built. This indoor air neuron comprises physical qualities of the air inside a space/room. With reference to FIG. 9, the indoor air neuron may comprise state values such as air volume 910, furniture volume 915, heat from people 920, or heat from lighting.

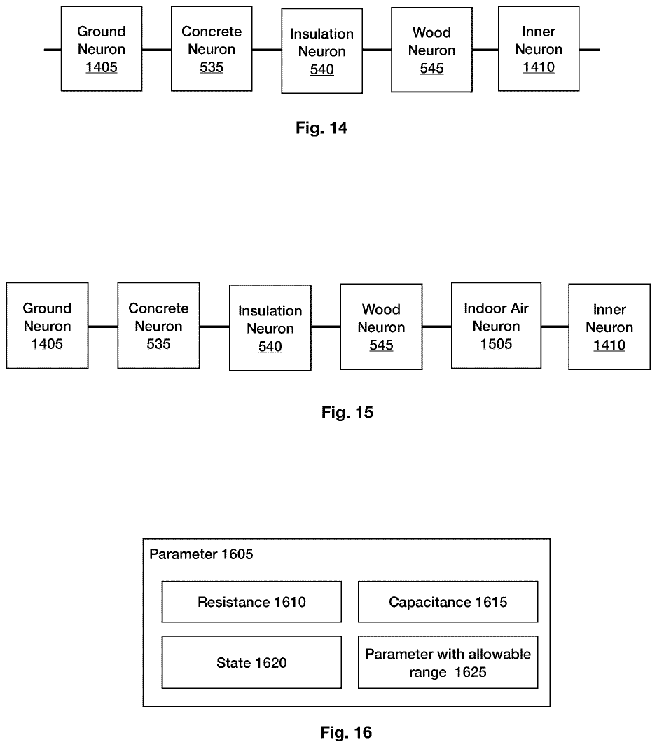

At 1150 the indoor air neuron is concatenated to an existing neuron string. The indoor air neuron is attached between an interior surface neuron and an inner neuron. With reference to FIG. 15, in an illustrative embodiment, the indoor air neuron 1505 is attached between the inner neuron 1415 and the wood neuron 545.

### IV. Exemplary System that Comprises Creating Neuron Strings for Multiple Rooms

In some embodiments, the digital representation of the structure comprises two or more rooms, and a wall is shared between the rooms. With reference to FIGS. 12 and 13, a structure with two rooms 1205, 1210 is shown that share a wall 1215 between them. A set of neuron strings 1340-1385 is associated with the first room 1205, 1300 and a set of neuron strings 1305-1335 is associated with the second room 1210, 1390. The shared wall 1215 is represented by one wall string 1355 in the the set of neuron strings associated with the first room. The wall is represented by no strings in the set of neuron strings associated with the second room, as there are only three neuron strings 1320A, 1320B, 1320C in the neuron string set representing room 2 1210, even though there are four walls, counting the shared wall. The wall string in the neuron string set representing the shared wall 1355 is not attached at the outside end to the outer neuron 1340 for its set as would be expected, but rather is attached to the inner neuron 1315 for room 2 1210. Notice that this shared wall neuron string is also attached at the other, inside end to the expected inner neuron 1350.

With reference to FIG. 16, a neuron can have a variety of parameters 1605. Some of these comprise resistance 1610, capacitance 1615, state 1620, parameters with allowable ranges 1625, and other parameters such as understood by those of skill in the art. These parameters can be queried, allowing information within the thermodynamic model to be determined. In some implementations, all parameters can be queried; in some implementations, only some parameters can be queried. In some implementations one or more of these parameters can be changed.

### V. Exemplary Computer-Readable Medium for Creation and Discretization of Neuron Models

With reference to FIGS. 11, 17 and 19, some embodiments include a configured computer-readable storage medium 1705. Media 1705 may include disks (magnetic, optical, or otherwise), RAM, EEPROMS or other ROMs, and/or other configurable memory, including computer-readable media (not directed to a manufactured transient phenomenon, such as an electrical, optical, or acoustical signal). The storage medium which is configured may be a removable storage medium 1705 such as a CD, DVD, or flash memory. A general-purpose memory (which may primary, such as RAM, ROM, CMOS, or flash; or may be secondary, such as a CD, a hard drive, an optical disk, or a removable flash drive), can be configured into an embodiment using items such as a neuron builder 1110, 1710 and a neuron concatenator 1120, in the form of data 1980 and instructions 1975, read from a source, such as a removable medium 1705, to form a configured medium. The configured medium 1970 is capable of causing a computer system to perform actions as related herein.

Some embodiments provide or utilize a computer-readable storage medium 1970 configured with software 1985 which upon execution by at least a central processing unit 1910 performs methods and systems described herein. In some embodiments the computer-readable storage medium is implemented in a system with memories 1920, 1940 coupled to one or more processors, such as the central processing unit 1910.

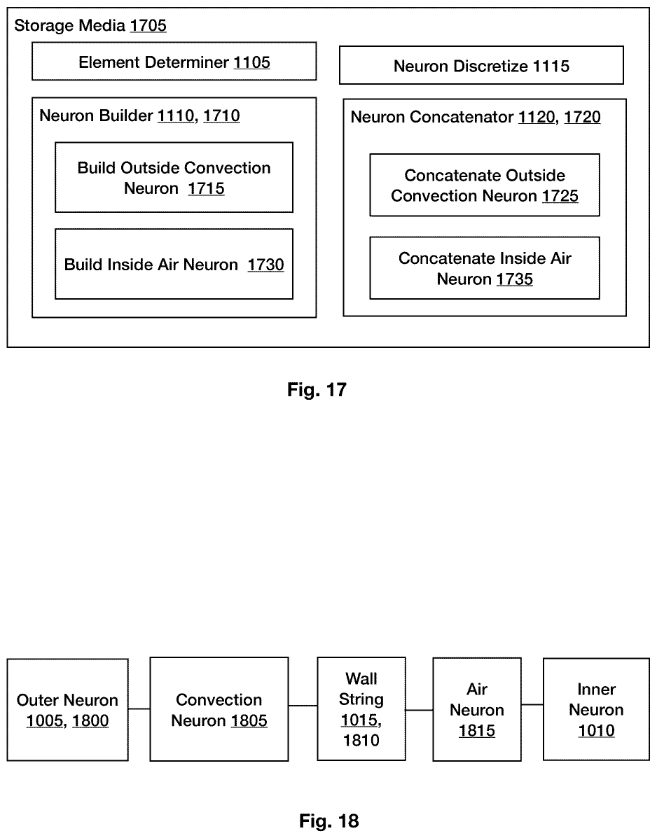

With continuing reference to FIG. 17, computer-readable storage media 1705 comprise an element determiner 1105 which determines structure elements for at least a first subsystem and a second subsystem in a digital representation of a structure. This is discussed with relation to FIGS. 5, 5A, 6, and 11 and the associated text.

The computer-readable storage media also comprises a neuron builder 1110, 1710 which builds a neuron for each structure element in a first subsystem and a second subsystem, as described with reference to FIGS. 5, 5A, 6, and 11 and associated text.

In an illustrative embodiment, the neuron builder also builds an outside convection neuron 1715. Convection is a type of heat transfer which occurs due to air movement. Thus, it may be modeled in neurons whose physical representations of structure elements touch air. Convection may be calculated as a resistance based on various parameters, such as: temperature difference between air and surface, wind velocity and direction, building geometry, and surface roughness. Exterior convection resistance lies between outdoor air neuron and exterior surface neuron and the interior convection resistance lies between indoor air neuron and interior surface neurons. Convection resistance is variable since it is function of environmental parameters. As such it may be modeled as a runtime value. In some embodiments convection neurons have only a resistance value. In an illustrative embodiment, the neuron builder also builds an inside air neuron 1730. The air neuron comprises the volume of space in a room or structure, the mass of furniture, and/or other factors that affect the air state. The air neuron models air between an interior surface neuron and an inner neuron, and as such is concatenated between an interior surface neuron and an inner neuron.

The computer-readable storage media also comprises a neuron concatenator 1720, which builds a extra neuron for each subsystem that has fewer structure elements that a subsystem with greatest number of structure elements, such that each subsystem has equal number of structure elements; and concatenating the neurons associated with the first subsystem making a first neuron string; and concatenates the neurons associated with the second subsystem making a second neuron string, the input of each next one of the neurons in a neuron string being connected to the output of a preceding one of the neurons, such that data is operationally able to be transferred along the neuron string. This is discussed with reference to FIGS. 5, 5A, 6, 7, and 11 and the related text.

The neuron concatenator also concatenates the outside convection neuron between the outside neuron and the first neuron string 1725. With reference to FIG. 18 at 1800, the outside convection neuron 1805 is placed between an outer neuron and a neuron representing a structure element that faces the outside, such as the outer edge of wall string 1810.

The neuron concatenator also concatenates the inner air neuron between an inner neuron and a neuron that touches inside air 1735. The inner air neuron 1815 is placed between an inner neuron 1010 and the inner edge of wall string 1015,1810, as it borders the inside air.

### VI. Computing Environment

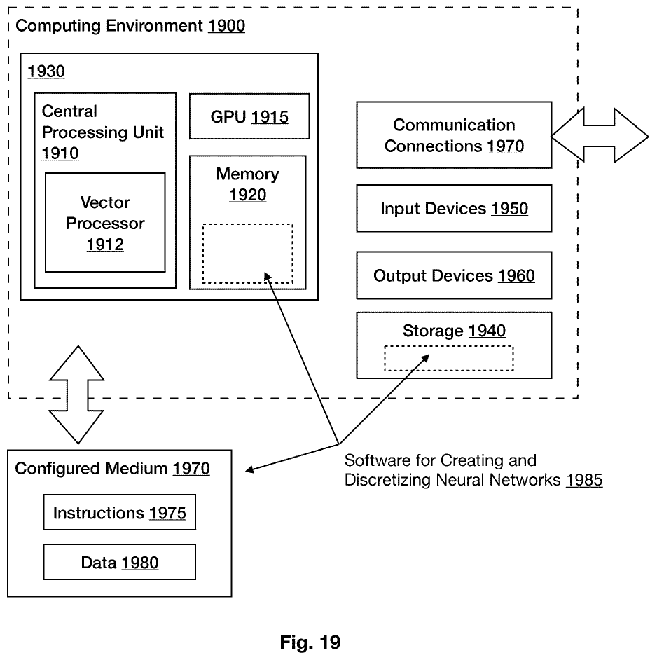

FIG. 19 illustrates a generalized example of a suitable computing environment 1900 in which described embodiments may be implemented. The computing environment 1900 is not intended to suggest any limitation as to scope of use or functionality of the disclosure, as the present disclosure may be implemented in diverse general-purpose or special-purpose computing environments.

With reference to FIG. 19, the computing environment 1900 includes at least one central processing unit 1910 and memory 1920. In FIG. 19, this most basic configuration 1930 is included within a dashed line. The central processing unit 1910 executes computer-executable instructions and may be a real or a virtual processor. It may also comprise a vector processor, which allows same-length neuron strings to be processed rapidly. The environment 1900 further includes the graphics processing unit GPU at 1915 for executing such computer graphics operations as vertex mapping, pixel processing, rendering, and texture mapping. In a multi-processing system, multiple processing units execute computer-executable instructions to increase processing power and as such the vector processor 1912, GPU 1915, and CPU can be running simultaneously. The memory 1920 may be volatile memory (e.g., registers, cache, RAM), non-volatile memory (e.g., ROM, EEPROM, flash memory, etc.), or some combination of the two. The memory 1920 stores software 1985 implementing the described methods of neural net creation and and discretization.

A computing environment may have additional features. For example, the computing environment 1900 includes storage 1940, one or more input devices 1950, one or more output devices 1960, and one or more communication connections 1970. An interconnection mechanism (not shown) such as a bus, controller, or network interconnects the components of the computing environment 1900. Typically, operating system software (not shown) provides an operating environment for other software executing in the computing environment 1900, and coordinates activities of the components of the computing environment 1900. The computing system may also be distributed; running portions of the software 1985 on different CPUs.

The storage 1940 may be removable or non-removable, and includes magnetic disks, magnetic tapes or cassettes, CD-ROMs, CD-RWs, DVDs, flash drives, or any other medium which can be used to store information and which can be accessed within the computing environment 1900. The storage 1940 stores instructions for the software 1985 to implement methods of neuron discretization and creation.

The input device(s) 1950 may be a touch input device such as a keyboard, mouse, pen, or trackball, a voice input device, a scanning device, touchscreen, or another device that provides input to the computing environment 1900. For audio, the input device(s) 1950 may be a sound card or similar device that accepts audio input in analog or digital form, or a CD-ROM reader that provides audio samples to the computing environment. The output device(s) 1960 may be a display, printer, speaker, CD-writer, or another device that provides output from the computing environment 1900.

The communication connection(s) 1970 enable communication over a communication medium to another computing entity. The communication medium conveys information such as computer-executable instructions, compressed graphics information, or other data in a modulated data signal. These connections may include network connections, which may be wireless connections, may include dial-up connections, and so on. The other computing entity may be a portable communications device such as a wireless handheld device, a cell phone device, and so on.

Computer-readable media are any available non-transient tangible media that can be accessed within a computing environment. By way of example, and not limitation, with the computing environment 1900, computer-readable media include memory 1920, storage 1940, communication media, and combinations of any of the above. Configurable media 1970 which may be used to store computer readable media comprises instructions 1975 and data 1980.

Moreover, any of the methods, apparatus, and systems described herein can be used in conjunction with combining abstract interpreters in a wide variety of contexts.

Although the operations of some of the disclosed methods are described in a particular, sequential order for convenient presentation, it should be understood that this manner of description encompasses rearrangement, unless a particular ordering is required by specific language set forth below. For example, operations described sequentially can be rearranged or performed concurrently. Moreover, for the sake of simplicity, the attached figures may not show the various ways in which the disclosed methods, apparatus, and systems can be used in conjunction with other methods, apparatus, and systems. Additionally, the description sometimes uses terms like “determine,” “build,” and “identify” to describe the disclosed technology. These terms are high-level abstractions of the actual operations that are performed. The actual operations that correspond to these terms will vary depending on the particular implementation and are readily discernible by one of ordinary skill in the art.

Further, data produced from any of the disclosed methods can be created, updated, or stored on tangible computer-readable media (e.g., tangible computer-readable media, such as one or more CDs, volatile memory components (such as DRAM or SRAM), or nonvolatile memory components (such as hard drives) using a variety of different data structures or formats. Such data can be created or updated at a local computer or over a network (e.g., by a server computer), or stored and accessed in a cloud computing environment.

In view of the many possible embodiments to which the principles of the disclosed invention may be applied, it should be recognized that the illustrated embodiments are only examples of the invention and should not be taken as limiting the scope of the invention. Rather, the scope of the invention is defined by the following claims. We therefore claim as our invention all that comes within the scope and spirit of these claims.

We claim:

1. A neuron model creation system comprising:
a memory; and
at least one processor configured to:
determine structure elements for at least a first subsystem and a second subsystem in a digital representation of a physical structure;
build a neuron for each structure element in the first subsystem and the second subsystem, each neuron comprising an input, an output, and at least one parameter;
modify at least one of the subsystems such that the first subsystem and the second subsystem are represented by an equal number of neurons;
connect the neurons associated with the first subsystem to form a first neuron string and connect the neurons associated with the second subsystem to form a second neuron string, each neuron string being branchless and ordered; and
execute the first neuron string and the second neuron string in parallel to model propagation of state through the physical structure.

2. The system of claim 1, wherein modifying at least one of the subsystems comprises adding one or more neurons to a subsystem having fewer structure elements than another subsystem.

3. The system of claim 2, wherein modifying the at least one of the subsystems comprises subdividing a neuron into multiple neurons whose combined parameter values correspond to parameter values of the subdivided neuron.

4. The system of claim 1, wherein the at least one parameter comprises a resistance value, a capacitance value, or a state value derived from a physical property of a structure element of a corresponding neuron.

5. The system of claim 1, wherein the first neuron string and the second neuron string comprise neuron strings, and wherein the neuron strings represent layered material elements of the physical structure.

6. The system of claim 5, wherein the neuron strings are configured such that state propagates through the neuron strings in a direction corresponding to physical transfer through the physical structure.

7. The system of claim 5, wherein the neuron strings are executed on vector processing hardware.

8. The system of claim 5, wherein the neuron strings collectively form a deterministic, structure-derived model of the physical structure.

9. The system of claim 1, wherein the system operates without a training phase and without adjustment of learned weights.

10. The system of claim 1, wherein parameters of the neurons are initialized based on physical properties of the structure elements rather than historical training data.

11. A method of modeling physical behavior of a structure using a self-configuring neural model, the method comprising:
deriving a digital representation of a physical structure comprising a plurality of subsystems;
identifying physical structure elements within each subsystem;
constructing a plurality of neuron strings, each neuron string corresponding to a subsystem and comprising an ordered, branchless sequence of neurons representing the physical structure elements of the subsystem;
initializing parameters of the neurons based on physical properties of the corresponding physical structure elements;
propagating one or more state values through the plurality of neuron strings to model transfer of state through the structure; and
automatically modifying at least one of the plurality of neuron strings based on the digital representation of the structure,
wherein the self-configuring neural model is generated and operates without training, without learned weights, and without use of historical training data.

12. The method of claim 11, wherein automatically modifying at least one of the plurality of neuron strings comprises adding, removing, or subdividing neurons to maintain correspondence between the at least one of the plurality of neuron strings and the physical structure elements.

13. The method of claim 11, wherein propagating the one or more state values comprises propagating thermodynamic state values through the plurality of neuron strings.

14. The method of claim 11, wherein initializing parameters of the neurons comprises assigning resistance, capacitance, or state parameters derived from material properties of the physical structure elements.

15. The method of claim 11, wherein the plurality of neuron strings are executed in parallel and interaction between the plurality of subsystems is represented by state propagation across multiple neuron strings.

16. A non-transient computer-readable storage medium storing instructions that, when executed by one or more processors, cause the one or more processors to implement a state-propagation engine configured to:
receive a digital representation of a physical structure comprising multiple subsystems;
generate, for each subsystem, a state-propagation path comprising an ordered sequence of computational nodes corresponding to physical structure elements;
normalize the state-propagation paths to a common length across the multiple subsystems;
propagate state values through the state-propagation paths to simulate physical transfer through the physical structure; and
update parameters of the computational nodes during propagation based on the propagated state values,
wherein the state-propagation engine operates deterministically based on the digital representation of the physical structure and does not perform a training phase or weight-learning operation.

17. The non-transient computer-readable storage medium of claim 16, wherein the computational nodes correspond to layers of materials within the physical structure.

18. The non-transient computer-readable storage medium of claim 16, wherein normalizing the state-propagation paths comprises subdividing at least one computational node into multiple computational nodes whose combined parameter values correspond to a parameter value of an original node.

19. The non-transient computer-readable storage medium of claim 16, wherein propagating state values comprises propagating at least one of temperature, energy, or environmental state through the state-propagation paths.

20. The non-transient computer-readable storage medium of claim 16, wherein the state-propagation engine executes the state-propagation paths in parallel on vector processing hardware.
